(19) United States
(12) Patent Application Publication
(10) Pub. No.: US 2019/0382534 A1
(43) Pub. Date: Dec. 19, 2019

(54) POLYSULFONE AND METHOD FOR MANUFACTURING THE SAME, RESIN COMPOSITION COMPRISING THE POLYSULFONE AND METHOD FOR MANUFACTURING THE SAME

(71) Applicant: DAXIN MATERIALS CORPORATION, Taichung City (TW)

(72) Inventors: Dian-Cing Lin, Taichung City (TW); Min-Tzu Kao, Taichung City (TW)

(21) Appl. No.: 16/260,063

(22) Filed: Jan. 28, 2019

(30) Foreign Application Priority Data
Jun. 15, 2018 (TW) 107120627

(51) Int. Cl. C08G 75/23; C08L 81/06; B32B 27/28; B32B 27/08; B32B 7/06; B32B 37/06

(52) U.S. Cl. CPC C08G 75/23; C08L 81/06; B32B 27/286; B32B 27/08; B32B 2386/00; B32B 37/06; B32B 2255/10; B32B 2457/14; B32B 7/06

(57) ABSTRACT

This invention provides a polysulfone with a formula (I) as below:

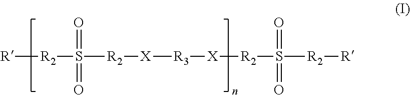

wherein, R₂ independently represents a substituted or unsubstituted aromatic ring; X is a linking group having both an ester group and a hydroxyl group; R₃ is an aliphatic linking group with more than 3 carbons or an aromatic linking group with at least two aromatic rings, and at least two of the aromatic rings are joined by an oxygen atom, a sulfur atom, a isopropylidene group or a hexafluoroisopropylidene group; and R′ is an terminal group with an epoxy group.

This application claims the benefit of Taiwanese application serial No.107120627, filed on Jun. 15, 2018, the subject matter of which is incorporated herein by reference.

### BACKGROUND OF THE INVENTION

### Field of the Invention

The invention relates in general to a polymer and a method for manufacturing the same, a resin composition comprising the polymer and a method for manufacturing the same, and a lamination method for substrates by using the composition comprising the polymer, and in particular relates in general to a polysulfone and a method for manufacturing the same, a resin composition comprising the polysulfone and a method for manufacturing the same, and a lamination method for substrate by using the resin composition comprising the polysulfone.

### Description of the Related Art

The silicon wafer is usually temporarily laminated to a carrier substrate by a laminating material to facilitate the manufacturing operation in the production line of the semiconductor packaging process. The lamination is proceeded at a temperature no more than 220° C., thus the bending of the silicon wafer, damage of the interface and leak of gas can be avoided. In addition, the semiconductor package process includes a temporary high temperature (>260° C.) treatment, and the laminating materials without heat resistance will suffer from deformation and/or server overflow.

Conventional polysulfone products all claim the features of high glass transition temperature (Tg), heat-resistant, acid-resistant and base-resistant, for example Ultrason® E (Polyethersulfone; PES), S (Polysulfon; PSU) and P (Polyphenylsulfone; PPSU) of BASF, Veradel® PESU (Polyethersulfone) of Solvey, or other polymers with glass transition temperatures between 220° C. to 240° C. or higher. When these conventional polysulfones are used to laminating semiconductor substrates, the laminating process must be proceeded at a temperature higher than 220° C. because each of these polysulfones has a glass transition temperature higher than 220° C. or has a more rigid structure. It will cause some problems such as the bending of the silicon wafer, the damage of the interface or gas leaking. Therefore, these conventional polysulfones are not suitable be used as laminating materials for semiconductor packaging process.

Accordingly, a laminating material that can be used to laminate semiconductor substrates at a lower temperature to provide excellent lamination efficiency and be free from deformation and overflow in other high temperature processes is highly expected.

### SUMMARY OF THE INVENTION

In one aspect, this invention provides a polysulfone represented by formula (I):

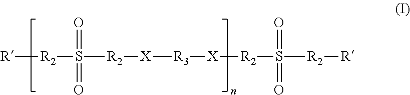

The abovementioned polysulfone represented by formula (I), wherein, R₂ independently represents a substituted or unsubstituted aromatic ring; X represents a linking group containing an ester group and a hydroxyl group; R₃ represents a aliphatic linking group with 3 or more carbon atoms or an aromatic linking group having 2 or more aromatic rings, where at least two aromatic rings are joined by an oxygen atom, a sulfur atom, a propylene group or a hexafluoroisopropylidene group; n equals to 30 to 200; and R′ represents an terminal group containing an epoxy group. By means of the polysulfone having a sulfonyl unit and a soft linking group of R₃, the softening temperature of the material can be adjusted to make the semiconductor be temporarily laminated at a lower operation temperature during packaging process. Contrarily, the lamination efficiency at a lower operation temperature will be worse if the soft linking group R₃ is replaced by a rigid linking group such as the phenyl or biphenyl group. Besides, the polysulfone of this present invention has an terminal group containing an epoxy group which can enhance its high temperature resistance to make the resin composition free from be deformed and severely overflowed when the laminating is proceeded at a high temperature.

Another aspect of this invention is to provide a resin composition, comprising the said polysulfone, a polymer different from the said polysulfone represented by formula (I) or (I-a) and having a main chain containing a sulfonyl unit, and an organic solvent.

Another aspect of this invention is to provide a lamination method for substrates, comprising the steps of: providing a first substrate; providing the said resin composition and coating on the first substrate; heating to remove the organic solvent from the said resin composition; and providing a second substrate and laminating the second substrate to the first substrate to sandwich the resin composition therebetween.

### BRIEF DESCRIPTION OF THE DRAWINGS

FIGS. 1A-1D are cross-sectional views of a lamination method for substrates according to one embodiment of this invention.

FIGS. 2A-2D are cross-sectional views of a lamination method for substrate according to another embodiment of this invention.

### DETAILED DESCRIPTION OF THE INVENTION

In one aspect, this invention provides a polysulfone represented by formula (I):

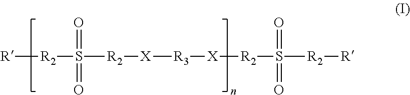

wherein, R₂ independently represents a substituted or unsubstituted aromatic ring; X represents a linking group containing an ester group and a hydroxyl group; R₃ represents a aliphatic linking group having 3 or more carbon atoms or an aromatic linking group having 2 or more aromatic rings, where at least two aromatic rings are joined by an oxygen atom, a sulfur atom, a propylene group or a hexafluoroisopropylidene group; n equals to 30 to 200, preferably 38-194; and R′ represents an terminal group containing an epoxy group.

The above-mentioned polysulfone represented by formula (I) is preferably the compound represented by formula (I-a):

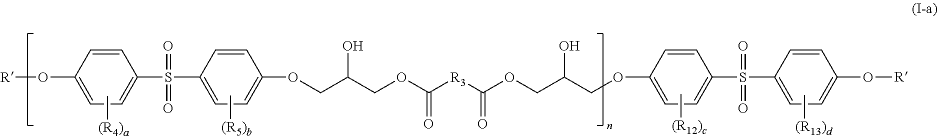

wherein,

each of R₄, R₅, R₁₂, R₁₃ independently represents a hydrogen atom, a chlorine atom, a bromine atom, or a group containing an aromatic ring, and R₄, R₅, R₁₂, R₁₃ can be the same or different;

each of a, b, c and d independently equals to 0 to 4

R₃, R′ and n are defined as above.

The above-mentioned polysulfone represented by formula (I), wherein R₃ represents C3-C10 linear or branched alkylene group, C3-C10 linear or branched alkenyl group, a C3-C20 alicyclic linking group, and the C3-C10 linear or branched alkylene group is unsubstituted and/or at least one —CH2- of the C3-C10 linear or branched alkylene group is replaced by a carbonyl group (—C═O—) or an oxy group (—O—), provided that the carbonyl group (—C═O—) and the oxy group (—O—) do not directly bond to each other, or a linking group represented by formula (II):

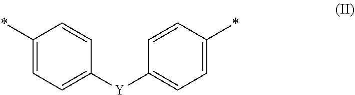

wherein,

Y represents an oxygen atom, a sulfur atom, a propylene group or a hexafluoroisopropylidene group;

R₃ preferably represents

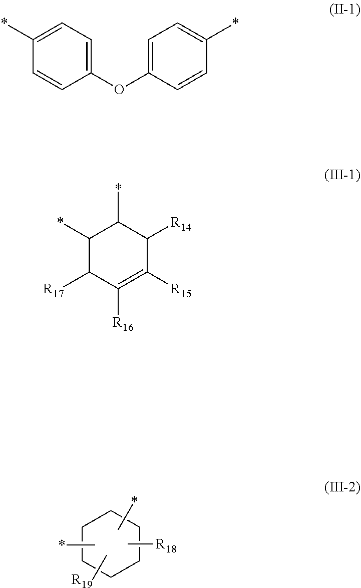

wherein R₁₄, R₁₅, R₁₆, R₁₇, R₁₈ and R₁₉ independently represents a hydrogen atom or a methyl group.

The above-mentioned polysulfone represented by formula (I), wherein R′ can be oxiranyl, oxetanyl, epoxycyclopentyl, or epoxycyclohexyl, preferably a terminal group containing formula (IV):

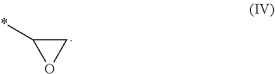 [SMILES: *C1CO1]

The above-mentioned polysulfone represented by formula (I), wherein the linking group containing an ester group and a hydroxyl group is formed by reacting a carboxyl group of a dicarboxylic acid with an epoxy group of a diepoxide having a sulfonyl unit.

The above-mentioned polysulfone represented by formula (I), wherein the diepoxide having a sulfonyl group has a structure represented by formula (V):

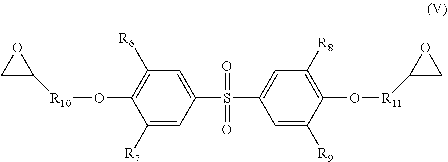

wherein, each of R₆-R₉ independently represents a hydrogen atom, a chlorine atom, a bromine atom or a group comprising an aromatic ring, and each of R₁₀ and R₁₁ independently represents a hydrocarbon group having one or more carbon atoms, or a divalent linking group having a chained structure containing an ether, an aromatic ring or combinations thereof.

The above-mentioned polysulfone represented by formula (I), wherein the dicarboxylic acid comprises one of the dicarboxylic acids containing linear or branched alkylene group, alicyclic linking group containing dicarboxylic acids or dicarboxylic acids with two or more aromatic rings, wherein at least two aromatic rings are joined by an oxygen atom, a sulfur atom, a propylene group or a hexafluoroisopropylidene group, for example but not limited to one of the group consisting of cis-butenedioic acid, trans-butenedioic acid, oxaloacetic acid, hexanedioic acid or the derivative thereof, pentanedioic acid or the derivative thereof, succinic acid, propanedioic acid or the derivative thereof, heptanedioic acid, suberic acid, nonanedioic acid, decanedioic acid, ketopimelic acid, 4,4′-oxybisbenzoic acid, cis-4-cyclohexene-1,2-dicarboxylic acid, and trans-4-cyclohexene-1,2-dicarboxylic acid or combinations thereof. The dicarboxylic acid preferably comprises one of linear alkylene group containing dicarboxylic acids, alicyclic linking group containing dicarboxylic acids or dicarboxylic acids with two or more aromatic rings, wherein at least two aromatic rings are joined by an oxygen atom, a sulfur atom, a propylene group or a hexafluoroisopropylidene group, and more preferably comprises one of alicyclic linking group containing dicarboxylic acids or dicarboxylic acids with two or more aromatic rings, wherein at least two aromatic rings are joined by an oxygen atom, a sulfur atom, a propylene group or a hexafluoroisopropylidene group, for example but not limited to 4,4′-oxybisbenzoic acid, cis-4-cyclohexene-1,2-dicarboxylic acid, and trans-4-cyclohexene-1,2-dicarboxylic acid.

Another aspect of this invention is to provide a method of manufacturing the above-mentioned polysulfone, the steps comprising: providing a reaction mixture of a dicarboxylic acid and a diepoxide having a sulfonyl unit, wherein the molar equivalent ratio of the diepoxide having a sulfonyl unit relative to the dicarboxylic acid is greater than 1; dissolving the reaction mixture into a solvent and heating to polymerize the dicarboxylic acid and the diepoxide having a sulfonyl unit therein in the present of a catalyst; and stopping heating the mixture to terminate the polymerization after ensuring the dicarboxylic acid is completely reacted.

Another aspect of this invention is to provide a resin composition, comprising the said polysulfone, a polymer different from the said polysulfone represented by formula (I) or (I-a) and having a main chain containing a sulfonyl unit, and an organic solvent.

The resin composition as mentioned above, wherein the organic solvent comprise at least one of the group consisting of pyrrolidone type solvents, such as N-Methyl-2-pyrrolidone, N-ethyl-2-pyrrolidone, ester type solvents, such as propylene glycerol methyl ether acetate, amide type solvents, such as N,N-dimethylacetamide, N,N-dimethylformamide, ether type solvents, such as dimethyl sulfoxide, propylene glycol monomethyl ether, tetrahydrofuran, and γ-butyrolactone, or combinations thereof. According to other embodiments of this invention, when considering the solubility of the said polysulfone or the said resin composition in the solvent or the volatilization rate of solvents during coating process, the solvents can be adjusted by using an aprotic polar solvent such as NMP of this present invention as a major solvent and using other types of solvent as co-solvent preferably including pyrrolidone type solvents or ester type solvents.

The above-mentioned polymer different from the polysulfone represented by formula (I) or (I-a) and having a main chain containing a sulfonyl unit can be but not limited to commercially available polysulfones such as Ultrason® E (Polyethersulfone; PES), Veradel® PESU (Polyethersulfone), Ultrason® S (Polysulfon; PSU) or Ultrason® P (Polyphenylsulfone; PPSU), or one of acrylic resins, polyamic acids, polyimides, polyamides and polybenzoxazoles containing a sulfonyl unit in the main chain, which can adjust the characters of the resin composition including heat resistance, deformation resistance and overflow at a high temperature.

In accordance with some embodiments, the content of the polysulfone of this invention is 5-55 weight %, preferably 10-40 weight %, and most preferably 10-35 weight %; the content of the polymer different from the polysulfone represented by formula (I) or (I-a) and having a main chain containing a sulfonyl unit is 1-25 weight %, preferably 5-15 weight %, and most preferably 5-10 weight %; the content of the organic solvent is 30-90 weight %, preferably 35-75 weight %, and most preferably 50-75 weight %, based on a total weight of the resin composition.

The resin composition as mentioned above can further comprises at least one of a leveling agent, a cosolvent, a surfactant and a silane coupling agent if necessary. The silane coupling agent can be but not limited to BYK 3620, LAPONITE-EP, BYK 302, BYK307, BYK331, BYK333, BYK342, BYK346, BYK347, BYK348, BYK349, BYK375, BYK377, BYK378, BYK3455 or BYK SILCLEAN 3720. The leveling agent can be but not limited to the silane series leveling agents such as BYK-375, the acrylate type leveling agents such as BYK381 or low M.W. surface active polymers. The surfactant can be but not limited to BYK-3410. The cosolvent can be but not limited to ester type solvents such as propylene glycerol methyl ether acetate or γ-butyrolactone. The content of the leveling agent is 0-5 weight %, preferably 0.05-1 weight %, and most preferably 0.1-0.5 weight %; the content of the cosolvent is 1-30 weight %, preferably 5-15 weight %, and most preferably 5-10 weight %, based on a total weight of the resin composition.

Another aspect of this invention is to provide a method for substrates laminating, comprising the steps of: providing a first substrate; providing the resin composition coating on the first substrate; heating to remove the organic solvent from the resin composition; and providing a second substrate and laminating the second substrate to the first substrate to sandwich the resin composition therebetween.

The method for substrates laminating as mentioned above, wherein the heat treatment is proceeding at a temperature ranging from 80° C. to 180° C. to completely remove the organic solvent from the resin composition, preferably increasing the heating temperature by gradient, for example heating at 80° C. for minutes first, then increasing the temperature to 130° C. and heating for a period of time, then increasing the temperature to 180° C. to completely remove the organic solvent.

The method for substrates laminating as mentioned above, wherein the step of laminating the second substrate to the first substrate is proceeded at a temperature of 220° C. or lower, preferably between 180° C. to 220° C., to avoid the second substrate being damaged by high temperature

The method for substrates laminating as mentioned above further comprises a step of forming a surface-treated layer on the first substrate before the step of coating the resin composition on the first substrate to make the resin composition be sandwiched between the surface-treated layer and the second substrate after the second substrate is laminated to the first substrate.

The lamination method for substrates as mentioned above, wherein the surface-treated layer is a release layer made of a material comprising one of the groups consisting of acrylic resins, polyimides, polyamides, polyamic acids and polybenzoxazoles, or combination thereof, and can further comprises multiple inorganic particles including but not limited to carbon black particles.

This invention will be further described by way of the following examples. However, it should be understood that the following examples are solely intended for the purpose of illustration and should not be construed as limiting the invention in practice.

### SYNTHETIC EXAMPLE

### Preparation of Polymeric Mixture

### Synthetic Example 1

Synthesis of Mixture (P-I)

Reactants of 67 g Bisphenol S Diglycidyl Ether (CAS 3878-43-1), 22.5 g adipic acid (CAS 124-04-9), 0.18 g 1-Methylimidazole (CAS 616-47-7), 179 g N-Methyl-2-pyrrolidone (CAS 872-50-4) were placed into a glass vessel and dry air was introduced below the surface of the liquid in the glass vessel for 30 minutes, then the reactants were heated to 100° C. and reacted for 10-12 hours. During the reaction period, the reaction rate was monitored by acid value determination. When the adipic acid was confirmed being completely reacted by acid value determination, the glass vessel was cooled down to terminate the reaction to obtain the Mixture (P-I) comprising polymer (I) with following structure formula:

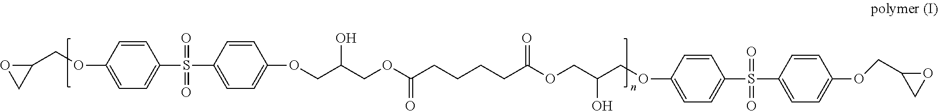

By gel permeation chromatography (GPC) measurement, the mixture (P-I) has a weight average molecular weight of 31000. 3.25 g solid synthetic polymer can be obtained by placing 10 g of mixture (P-I) in a flask of a rotary evaporator and removing the solvent therein by heating under diminished pressure. The solid content of the mixture (P-I) is 32.5 weight %.

### Synthetic Example 2

Synthesis of Mixture (P-II)

Reactants of 67 g Bisphenol S Diglycidyl Ether (CAS 3878-43-1), 39.8 g 4-4-Oxybis (benzoic acid) (CAS. 2215-89-6), 0.21 g 1-Methylimidazole (CAS 616-47-7), 213 g N-Methyl-2-pyrrolidone (CAS 872-50-4) were placed into a glass vessel and dry air was introduced below the surface of the liquid in the glass vessel for 30 minutes, then the reactants were heated to 100° C. and reacted for 10-12 hours. During the reaction period, the reaction rate was monitored by acid value determination. When the adipic acid was confirmed being completely reacted by acid value determination, the glass vessel was cooled down to terminate the reaction to obtain the Mixture (P-II) comprising polymer (II) with following structure formula:

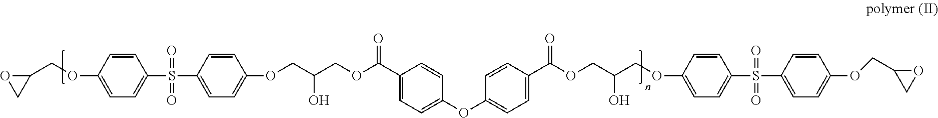

By gel permeation chromatography (GPC) measurement, the mixture (P-II) has a weight average molecular weight of 40000. 3.25 g solid synthetic polymer can be obtained by placing 10 g of mixture (P-II) in a flask of a rotary evaporator and removing the solvent therein by heating under diminished pressure. The solid content of the mixture (P-II) is 32.5 weight %.

### Synthetic Example 3

Synthesis of Mixture (P-III)

Reactants of 67 g Bisphenol S Diglycidyl Ether (CAS 3878-43-1), 26.2 g 1,2,3,6-tetrahydrophthalic acid (CAS 88-98-2), 0.19 g 1-Methylimidazole (CAS 616-47-7), 186 g N-Methyl-2-pyrrolidone (872-50-4) were placed into a glass vessel and dry air was introduced below the surface of the liquid in the glass vessel for 30 minutes, then the reactants were heated to 100° C. and reacted for 10-12 hours. During the reaction period, the reaction rate was monitored by acid value determination. When the adipic acid was confirmed being completely reacted by acid value determination, the glass vessel was cooled down to terminate the reaction to obtain the Mixture (P-III) comprising polymer (III) with following structure formula:

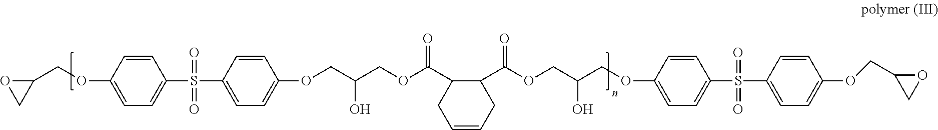

By gel permeation chromatography (GPC) measurement, the mixture (P-III) has a weight average molecular weight of 34000. 3.25 g solid synthetic polymer can be obtained by placing 10 g of mixture (P-III) in a flask of a rotary evaporator and removing the solvent therein by heating under diminished pressure. The solid content of the mixture (P-III) is 32.5 weight %.

### Synthetic Example 4

Synthesis of Mixture (P-IV)

Reactants of 62.6 g Bisphenol A Diglycidyl Ether (CAS.1675-54-3), 22.5 g adipic acid (CAS 64-19-7), 0.21 g 1-Methylimidazole (CAS 616-47-7), 175 g N-Methyl-2-pyrrolidone (872-50-4) were placed into a glass vessel and dry air was introduced below the surface of the liquid in the glass vessel for 30 minutes, then the reactants were heated to 100° C. and reacted for 10-12 hours. During the reaction period, the reaction rate was monitored by acid value determination. When the adipic acid was confirmed being completely reacted by acid value determination, the glass vessel was cooled down to terminate the reaction to obtain the Mixture (P-IV) comprising polymer (IV) with following structure formula:

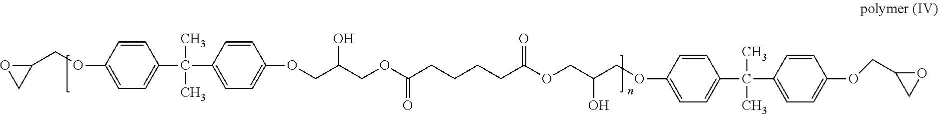

By gel permeation chromatography (GPC) measurement, the mixture (P-IV) has a weight average molecular weight of 42000. 3.25 g solid synthetic polymer can be obtained by placing 10 g of mixture (P-IV) in a flask of a rotary evaporator and removing the solvent therein by heating under diminished pressure. The solid content of the mixture (P-IV) is 32.5 weight %.

### Synthetic Example 5

Synthesis of Mixture (P-V)

Reactants of 62.8 g Bisphenol S Diglycidyl Ether (CAS. 3878-43-1), 39.8 g 4-4-Oxybis (benzoic acid) (CAS. 2215-89-6), 0.21 g 1-Methylimidazole (CAS 616-47-7), 205 g N-Methyl-2-pyrrolidone (872-50-4) were placed into a glass vessel and dry air was introduced below the surface of the liquid in the glass vessel for 30 minutes, then the reactants were heated to 100° C. and reacted for 10-12 hours. During the reaction period, the reaction rate was monitored by acid value determination. When the adipic acid was confirmed being completely reacted by acid value determination, the glass vessel was cooled down to terminate the reaction to obtain the Mixture (P-V) comprising polymer (V) with following structure formula:

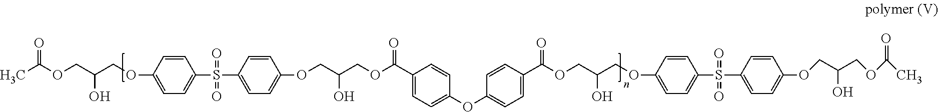

By gel permeation chromatography (GPC) measurement, the mixture (P-V) has a weight average molecular weight of 42000. 3.25 g solid synthetic polymer can be obtained by placing 10 g of mixture (P-V) in a flask of a rotary evaporator and removing the solvent therein by heating under diminished pressure. The solid content of the mixture (P-V) is 32.5 weight %.

Preparation of Resin Composition

### EXAMPLE 1

80 g mixture (P-I) obtained from synthetic example 1, 12 g N-Methyl-2-pyrrolidone (CAS 872-50-4), 7 g Propylene glycol methyl ether acetate (CAS 108-65-6), 0.2 g polyethersulfone 4100P (purchased from Sumitomo Chemical), 8 g BYK 375 (purchased from BYK) were placed into a flask, and mixed and blended to generate a resin composition 1 with a homogenous viscosity.

### EXAMPLE 2

80 g mixture (P-II) obtained from synthetic example 2, 12 g N-Methyl-2-pyrrolidone (CAS 872-50-4), 7 g Propylene glycol methyl ether acetate (CAS 108-65-6), 0.2 g polyethersulfone 4100P (purchased from Sumitomo Chemical), 8 g BYK 375 (purchased from BYK) were placed into a flask, and mixed and blended to generate a resin composition 2 with a homogenous viscosity.

### EXAMPLE 3

80 g mixture (P-II) obtained from synthetic example 2, 12 g N-Methyl-2-pyrrolidone (CAS 872-50-4), 7 g Propylene glycol methyl ether acetate (CAS 108-65-6), 8 g polyethersulfone 4100P (purchased from Sumitomo Chemical) were placed into a flask, and mixed and blended to generate a resin composition 3 with a homogenous viscosity.

### EXAMPLE 4

80 g mixture (P-III) obtained from synthetic example 3, 12 g N-Methyl-2-pyrrolidone (CAS 872-50-4), 7 g Propylene glycol methyl ether acetate (CAS 108-65-6), 0.2 g polyethersulfone 4100P (purchased from Sumitomo Chemical), 8 g BYK 375 (purchased from BYK) were placed into a flask, and mixed and blended to generate a resin composition 4 with a homogenous viscosity.

### EXAMPLE 5

70 g mixture (P-II) obtained from synthetic example 2, 18 g N-Methyl-2-pyrrolidone (CAS 872-50-4), 7 g Propylene glycol methyl ether acetate (CAS 108-65-6), 12 g polyethersulfone 4100P (purchased from Sumitomo Chemical), 0.2 g BYK 375 (purchased from BYK) were placed into a flask, and mixed and blended to generate a resin composition 5 with a homogenous viscosity.

### EXAMPLE 6

85 g mixture (P-II) obtained from synthetic example 2, 9 g N-Methyl-2-pyrrolidone (CAS 872-50-4), 7 g Propylene glycol methyl ether acetate (CAS 108-65-6), 6 g polyethersulfone 4100P (purchased from Sumitomo Chemical), 0.2 g BYK 375 (purchased from BYK) were placed into a flask, and mixed and blended to generate a resin composition 6 with a homogenous viscosity.

### EXAMPLE 7

80 g mixture (P-I) obtained from synthetic example 1, 12 g N-Methyl-2-pyrrolidone (CAS 872-50-4), 7 g Propylene glycol methyl ether acetate (CAS 108-65-6), 8 g Udel® PSU (purchased from Solvay), 0.2 g BYK 375 (purchased from BYK) were placed into a flask, and mixed and blended to generate a resin composition 7 with a homogenous viscosity.

### COMPARATIVE EXAMPLE 1

80 g mixture (P-IV) obtained from synthetic example 4, 12 g N-Methyl-2-pyrrolidone (CAS 872-50-4), 7 g Propylene glycol methyl ether acetate (CAS 108-65-6), 8 g polyethersulfone 4100P (purchased from Sumitomo Chemical), 0.2 g BYK 375 (purchased from BYK) were placed into a flask, and mixed and blended to generate a resin composition 8 with a homogenous viscosity.

### COMPARATIVE EXAMPLE 2

34 g polyethersulfone 4100P (purchased from Sumitomo Chemical), 0.2 g BYK 375 (purchased from BYK) and 66 g N-Methyl-2-pyrrolidone (CAS 872-50-4) were placed into a flask, and mixed and blended to generate a resin composition 9 with a homogenous viscosity.

### COMPARATIVE EXAMPLE 3

80 g mixture (P-V) obtained from synthetic example 5, 12 g N-Methyl-2-pyrrolidone (CAS 872-50-4), 7 g Propylene glycol methyl ether acetate (CAS 108-65-6), 8 g polyethersulfone 4100P (purchased from Sumitomo Chemical), 0.2 g BYK 375 (purchased from BYK) were placed into a flask, and mixed and blended to generate a resin composition 10 with a homogenous viscosity.

The resin compositions 1-7 for example 1-7 and the resin compositions 8-10 for comparative example 1-3 are list in following table 1.

TABLE 1

| | EXAM- | | EXAM- | | EXAM- | | EXAM- | | EXAM- | | EXAM- | | EXAM- | | Comparative | | Comparative | | Comparative | |
|---|---|---|---|---|---|---|---|---|---|---|---|---|---|---|---|---|---|---|---|---|
| | PLE 1 | | PLE 2 | | PLE 3 | | PLE 4 | | PLE 5 | | PLE 6 | | PLE 7 | | Example 1 | | Example 2 | | Example 3 | |
| | Compo- | | Compo- | | Compo- | | Compo- | | Compo- | | Compo- | | Compo- | | Compo- | | Compo- | | Compo- | |
| | sition 1 | | sition 2 | | sition 3 | | sition 4 | | sition 5 | | sition 6 | | sition 7 | | sition 8 | | sition 9 | | sition 10 | |
| Mixture (P-I) | 80 | g | — | | — | | — | | — | | — | | 80 | g | — | | — | | — | |
| Mixture (P-II) | — | | 80 | g | 80 | g | — | | 70 | g | 85 | g | — | | — | | — | | — | |
| Mixture (P-III) | — | | — | | — | | 80 | g | — | | — | | — | | — | | — | | — | |
| Mixture (P-IV) | — | | — | | — | | — | | — | | — | | — | | 80 | g | — | | — | |
| Mixture (P-V) | — | | — | | — | | — | | — | | — | | — | | — | | — | | 80 | g |
| Polyether- | 8 | g | 8 | g | 8 | g | 8 | g | 12 | g | 6 | g | — | | 8 | g | 34 | g | 8 | g |
| sulfone 4100p | | | | | | | | | | | | | | | | | | | | |
| Udel PSU | — | | — | | — | | — | | — | | — | | 8 | g | — | | — | | — | |
| N-Methyl-2- | 12 | g | 12 | g | 12 | g | 12 | g | 18 | g | 9 | g | 12 | g | 12 | g | 66 | g | 12 | g |
| pyrrolidone | | | | | | | | | | | | | | | | | | | | |

| | | | | | | | | | | | | | | | | | | |
|---|---|---|---|---|---|---|---|---|---|---|---|---|---|---|---|---|---|---|
| Propylene glycol | 7 | g | 7 | g | 7 | g | 7 | g | 7 | g | 7 | g | 7 | g | 7 | g | — | 7 |
| methyl ether acetate | | | | | | | | | | | | | | | | | | |

| | | | | | | | | | | | | | | | | | | | |
|---|---|---|---|---|---|---|---|---|---|---|---|---|---|---|---|---|---|---|---|
| BYK375 | 0.2 | g | 0.2 | g | — | 0.2 | g | 0.2 | g | 0.2 | g | 0.2 | g | 0.2 | g | 0.2 | g | 0.2 | g |

The characters of the compositions 1-10 were determined by 220° C. lamination efficiency test and high-temperature overflow test, and the testing results are shown in Table 2.

220° C. Lamination Efficiency Test

A round liquid resin composition pattern with a diameter of 7 mm and a thickness of 50 μm was coated on a 2 cm*2 cm glass substrate, wherein the liquid resin composition can be one of the resin compositions 1-7 for example 1-7 and the resin compositions 8-10 for comparative example 1-3. Next, the solvent was removed from the resin composition by sequentially heating at 80° C. for 10 minutes, 130° C. for 10 minutes and 180° C. for 10 minutes. Next, another 1 cm*1 cm glass substrate was placed on the liquid resin composition pattern and pressed with a 2 Kg weight thereon to provide a laminating press of 2 Kg/cm². The laminated substrates pressed with a 2 Kg weigh was proceeded at 220° C. for 10 minutes by a heating source such as a hot plate or an oven. Then, the area laminated by the resin composition was measured after the weight and the heating source were removed. If the laminating area was more than 90%, then the lamination efficiency was determined as ⊚; if the laminating area was about 80-90%, then the lamination efficiency was determined as ◯; if the laminating area was about 50-80%, then the lamination efficiency was determined as Δ; if the laminating area was less than 50%, then the lamination efficiency was determined as X.

High-Temperature Overflow Test

A round liquid resin composition pattern with a diameter of 7 mm and a thickness of 50 μm was coated on a 2 cm*2 cm glass substrate, wherein the liquid resin composition can be one of the resin compositions 1-7 for example 1-7 and the resin compositions 8-10 for comparative example 1-3. Next, the solvent was removed from the resin composition by sequentially heating at 80° C. for 10 minutes, 130° C. for 10 minutes and 180° C. for 10 minutes. Next, another 1.1 cm*1.1 cm glass substrate was placed on the liquid resin composition pattern and pressed with a 2 Kg weight thereon to provide a laminating press of 2 Kg/cm². The laminated substrates pressed with a 2 Kg weigh was proceeded at 220° C. for 10 minutes by a heating source such as a hot plate or an oven. Then, the area laminated by the resin composition was measured after the weight and the heating source were removed. The diameter of the area laminated by the resin composition was measured and determined as an original diameter. The laminated substrate was proceeded at 260° C. for 120 minutes, and the area laminated by the resin composition was measured after the heating source were removed. If the measured diameter of the laminating area was 95-105% of the original diameter, then the high-temperature overflow test was determined as ⊚; if the measured diameter of the laminating area was 105-115% of the original diameter, then the high-temperature overflow test was determined as ◯; if the measured diameter of the laminating area was 105-115% of the original diameter, then the high-temperature overflow test was determined as Δ; if the measured diameter of the laminating area was more than 150% of the original diameter, then the high-temperature overflow test was determined as X.

TABLE 2

| | | | Polymer | | |
|---|---|---|---|---|---|
| | | | with(Y) or | | |
| | | | without(N) | | |
| | | Polymer | an terminal | | |
| | Molecular | with(Y) or | group | | High- |
| Resin | Weight | without(N) | containing an | 220° C. Lamination | temperature |
| Composition | (M.W.). | a sulfonyl unit | epoxy group | efficiency Test | Overflow Test |
| Example1 | 31000 | Y | Y | ⊚ | ◯ |
| Example2 | 40000 | Y | Y | ⊚ | ⊚ |
| Example3 | 40000 | Y | Y | ⊚ | ⊚ |
| Example4 | 34000 | Y | Y | ⊚ | ⊚ |
| Example5 | 40000 | Y | Y | ⊚ | ⊚ |
| Example6 | 40000 | Y | Y | ⊚ | ◯ |
| Example7 | 31000 | Y | Y | ⊚ | ◯ |
| Comparative | 42000 | N | Y | ⊚ | X |
| Example 1 | | | | | |
| Comparative | 56000 | Y | N | X | NA |
| Example 2 | | | | | |
| Comparative | 39500 | Y | N | ⊚ | X |
| Example 3 | | | | | |

As shown in Table 2, the polymers (I)-(III) for example 1-7 are all polysulfones, and each of the polysulfones has a sulfonyl unit and a terminal group containing an epoxy group, thus characters of the resin compositions for example 1-7 determined by 220° C. laminating efficiency test and high-temperature overflow test indicate that each of the polysulfones having a sulfonyl unit and a terminal group containing an epoxy group can provide an excellent lamination efficiency and non-obvious overflow during the step of substrates lamination of the semiconductor process. Therefore, the polysulfone having a sulfonyl unit and a terminal group containing an epoxy group of this present invention is a suitable material for laminating substrates in the semiconductor process. Besides, as shown in Table 1, the compositions for example 2 and 3 are almost the same, and the sole difference is that the composition for example 2 further comprises 0.2 g of leveling agent BYK375. As shown in Table 2, there is no significant difference between example 2 and 3 in 220° C. lamination efficiency test and high-temperature overflow test, thus the leveling agent has no substantial effect on low-temperature lamination ability and high-temperature overflow of the resin compositions of this present invention.

As shown in Table 2, the polymer (V) for the comparative example 1 having a terminal group containing an epoxy group provides an excellent lamination efficiency but suffers from serve overflow during substrates lamination because it contains no sulfonyl unit.

As shown in Table 2, the polymer for the comparative 2 is a commercially available polyethersulfone 4100P (purchased from Sumitomo Chemical) with a glass transition temperature (Tg) of 230° C. The difference between polyethersulfone 4100P and the polymer (I) is polyethersulfone 4100P contains no —X—R₃—X— structure which causes the resin composition for the comparative example 2 unable to provide an excellent lamination efficiency.

As shown in Table 2, the polymer (V) for the comparative example 3 is a polysulfone containing a sulfonyl unit which provides an excellent lamination efficiency at 220° C. but suffers from obvious overflow when laminating at a high temperature because neither one of the terminals of the polymer (V) contains a terminal group containing an epoxy group.

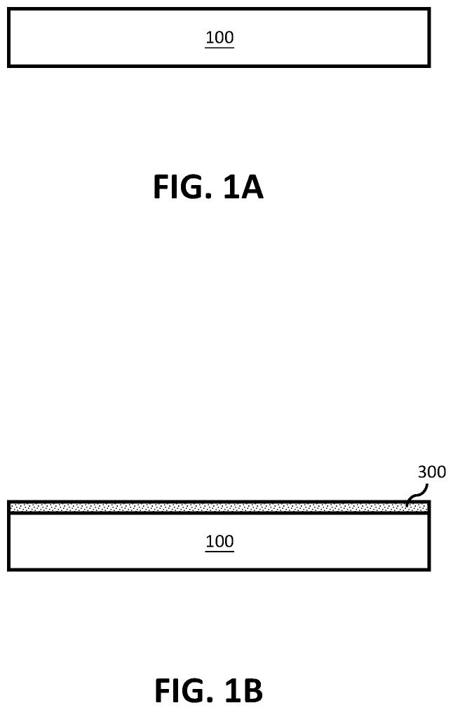

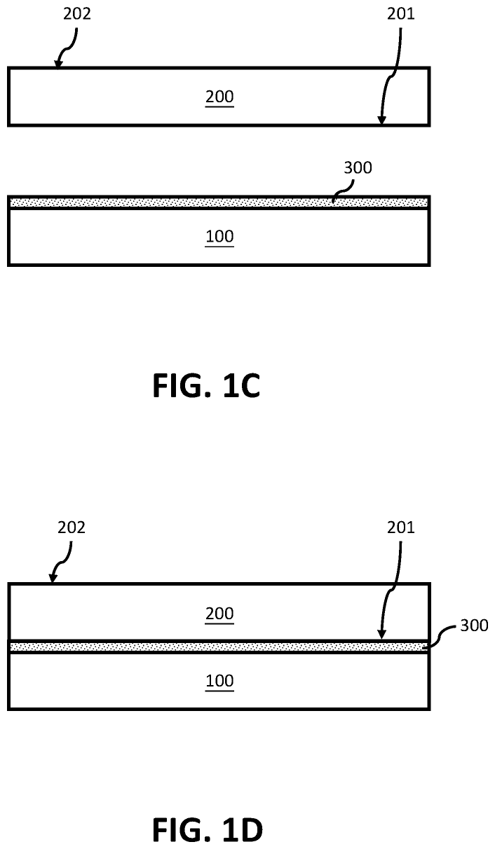

As mentioned above, each of the resin compositions of this present invention comprising a polysulfone containing a sulfonyl unit, —X—R₃—X—, and a terminal group containing an epoxy group has better performance on 220° C. lamination efficiency test and high-temperature overflow test. It indicates that the resin compositions of this present invention provide excellent lamination efficiency. Therefore, the resin compositions of this present invention are suitable to laminate substrates in semiconductor process. FIGS. 1A-1D are cross-sectional views illustrating the lamination method for substrates, comprising the steps of: providing a first substrate 100 as shown in FIG. 1A; providing a resin composition 300 of this present invention and coating on the top surface (not labeled) of the first substrate as shown in FIG. 1B, then heating at a temperature between 80° C. to 180° C. to remove the organic solvent from the resin composition 300; and providing a second substrate 200 as shown in FIG. 1C and laminating the second substrate 200 to the top surface (not labeled) of the first substrate 100 as shown in FIG. 1D to sandwich the resin composition 300 between the first substrate 100 and the second substrate 200.

The first substrate 100 is used as a carrier which can be made of a material for example but not limited to silicon, glass or other heat-resistant materials. The dimension of the first substrate 100 is usually larger than that of the second substrate 200 to facilitate its carrying ability for the second substrate 200 with various shapes and dimension in the production line. The second substrate 200 for the semiconductor package process can be but not limited to a wafer, and wirings or re-distribution structures for electronic signal channels of a chip can be formed on the backside 201 of the second substrate 200. The resin composition 300 of this present invention is used as a laminating material, and the second substrate 200 can be laminated to the first substrate 100 by sandwiched the resin composition 300 therebetween. Besides, the resin composition 300 can make the processing surface 202 of the second substrate 200 be easily processed, modified such as manufacturing metallic wirings or forming through holes on its surface, and even subsequent contacting with chips or module materials. Moreover, the structures on the backside 201 of the second substrate 200 can also be protected from being damaged when being operated at a high temperature. The second substrate 200 can be released from the first substrate 100 by means of heating the resin composition, applying an external force to the resin composition or laser releasing to damage the resin composition 300 after the package process is finished.

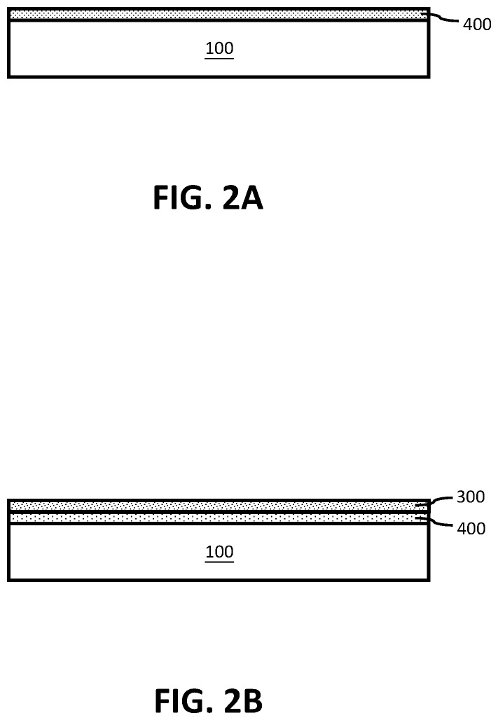

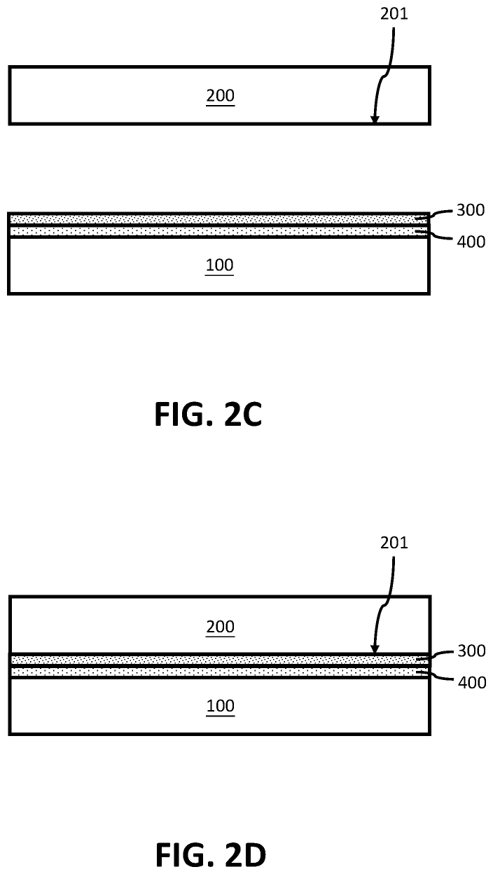

FIGS. 2A-2D are cross-sectional views illustrating another lamination method for substrates of this present invention. As shown in FIGS. 2A-2D, the top surface between the first substrate 100 and the resin composition 300 was pre-treated, for example forming a release layer 400 on the top surface (not labeled) of the first substrate 100 as shown in FIG. 2A to facilitate the first substrate 100 to peel off the second substrate 200 in following process. The release layer 400 can be made of a material comprising one of the groups consisting of acrylic resins, polyimides, polyamides, polyamic acids and polybenzoxazoles, or combination thereof, and can further comprises multiple inorganic particles including but not limited to carbon black particles. Next, as shown in FIG. 2B, a resin composition 300 was coated on the release layer 400, and heated at a temperature between 80° C. to 180° C. for a period of time to remove the organic solvent from the resin composition 300. Next, a second substrate 200 as shown in FIG. 2C was provided and laminated to the top surface (not labeled) of the first substrate 100 at a temperature between 180° C. to 220° C. to sandwich the resin composition 300 between the first substrate 100 and the second substrate 200 as shown in FIG. 2D.

As mentioned above, this disclosure provides a polysulfone containing a sulfonyl unit, —X—R₃—X—, and a terminal group containing an epoxy group and a resin composition comprising the polysulfone, improved excellent lamination efficiency within 220° C. lamination efficiency test and high-temperature overflow test. Therefore, the resin compositions of this present invention are suitable to laminate substrates in the semiconductor process, especially at a lower temperature.

Although particular embodiments have been shown and described, it should be understood that the above discussion is not intended to limit the present invention to these embodiments. Persons skilled in the art will understand that various changes and modifications may be made without departing from the scope of the present invention as literally and equivalently covered by the following claims.

What is claimed is:

1. A polysulfone represented by formula (I): 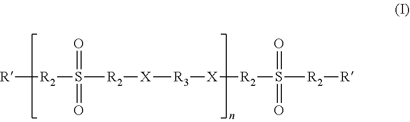
wherein,
R₂ independently represents a substituted or unsubstituted aromatic ring;
X represents a linking group containing an ester group and a hydroxyl group;
R₃ represents an aliphatic linking group with 3 or more carbon atoms or an aromatic linking group having 2 or more aromatic rings, where at least two aromatic rings are joined by an oxygen atom, a sulfur atom, a propylene group or a hexafluoroisopropylidene group;
n equals to 30 to 200; and
R′ represents a terminal group containing an epoxy group.

2. The polysulfone as claimed in claim 1, wherein the polysulfone represented by formula (I) is the compound represent by formula (I-a): 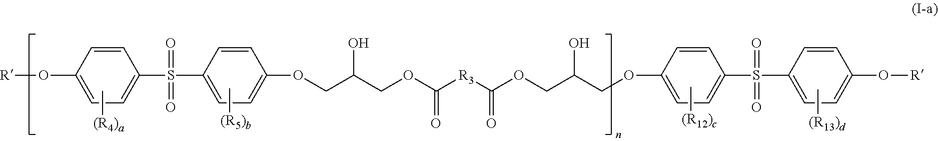
wherein,
each of R₄, R₅, R₁₂, R₁₃ independently represents a hydrogen atom, a chlorine atom, a bromine atom or a group containing an aromatic ring, and R₄, R₅, R₁₂, R₁₃ can be the same or different;
each of a, b, c and d independently equals to 0 to 4; and
R₃, R′ and n are defined as claim 1.

3. The polysulfone as claimed in claim 1, wherein R₃ represents C3-C10 linear or branched alkylene group, C3-C10 linear or branched alkenyl group, a C3-C20 alicyclic linking group, and the C3-C10 linear or branched alkylene group is unsubstituted and/or at least one —CH2- of the C3-C10 linear or branched alkylene group is replaced by a carbonyl group (—C═O—) or an oxy group (—O—), provided that the carbonyl group (—C═O—) and the oxy group (—O—) do not directly bond to each other, or a linking group represented by formula (II): 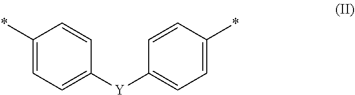
wherein Y represents an oxygen atom, a sulfur atom, a propylene group or a hexafluoroisopropylidene group.

4. The polysulfone as claimed in claim 1, wherein R′ represents the terminal group containing formula (IV):

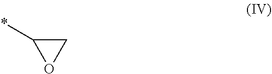 [SMILES: *C1CO1]

5. The polysulfone as claimed in claim 1, wherein the linking group containing an ester group and a hydroxyl group is formed by reacting a carboxyl group of a dicarboxylic acid with an epoxy group of a diepoxide having a sulfonyl group.

6. The polysulfone as claimed in claim 5, wherein the diepoxide having a sulfonyl group has a structure represented by formula (V): 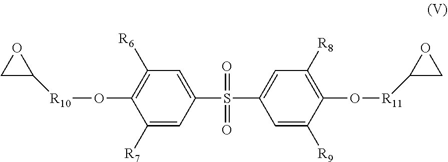
wherein, each of R₆-R₉ independently represents a hydrogen atom, a chlorine atom, a bromine atom or a group comprising an aromatic ring, and each of R₁₀ and R₁₁ independently represents a hydrocarbon group having one or more carbon atoms, or a divalent linking group having a chained structure containing an ether, an aromatic ring or combinations thereof.

7. The polysulfone as claimed in claim 5, wherein the dicarboxylic acid comprises one of the group consisting of cis-butenedioic acid, trans-butenedioic acid, oxaloacetic acid, hexanedioic acid or the derivative thereof, pentanedioic acid or the derivative thereof, succinic acid, propanedioic acid or the derivative thereof, heptanedioic acid, suberic acid, nonanedioic acid, decanedioic acid, ketopimelic acid, 4,4′-oxybisbenzoic acid, cis-4-cyclohexene-1,2-dicarboxylic acid, and trans-4-cyclohexene-1,2-dicarboxylic acid or combinations thereof.

8. A method of manufacturing the polysulfone as claimed in claim 5, comprising the steps of
providing a reaction mixture of a dicarboxylic acid and a diepoxide having a sulfonyl group, wherein the molar equivalent ratio of the diepoxide having a sulfonyl group relative to the dicarboxylic acid is greater than 1;
dissolving the reaction mixture into a solvent and heating to polymerize the dicarboxylic acid and the diepoxide in the present of a catalyst; and
stopping heating the mixture to terminate the polymerization after ensuring the dicarboxylic acid is completely reacted.

9. A resin composition, comprising:
a polysulfone represented by formula (I): 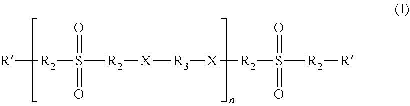
wherein,
R₂ independently represents a substituted or unsubstituted aromatic ring;
X represents a linking group containing an ester group and a hydroxyl group;
R₃ represents an aliphatic linking group with 3 or more carbon atoms or an aromatic linking group having 2 or more aromatic rings, where at least two aromatic rings are joined by an oxygen atom, a sulfur atom, a propylene group or a hexafluoroisopropylidene group;
n equals to 30 to 200; and
R′ represents a terminal group containing an epoxy group;
a polymer different from the polysulfone represented by formula (I) and having a main chain containing a sulfonyl unit; and
an organic solvent.

10. The resin composition as claimed in claim 9, wherein the organic solvent comprises at least one of the group consisting of N-Methyl-2-pyrrolidone, N-ethyl-2-pyrrolidone, propylene glycerol methyl ether acetate, N,N-dimethylacetamide, N,N-dimethylformamide, dimethyl sulfoxide, propylene glycol monomethyl ether, tetrahydrofuran, and γ-butyrolactone, or combinations thereof.

11. The resin composition as claimed in claim 9, further comprising at least one of a leveling agent, a cosolvent, a surfactant and a silane coupling agent.

12. A lamination method for substrates, comprising the steps of:
providing a first substrate;
providing a resin composition as claimed in claim 9 and coating on the first substrate;
heating to removing the organic solvent from the resin composition; and
providing a second substrate and laminating the second substrate to the first substrate to sandwich the resin composition therebetween.

13. The lamination method for substrates as claimed in claim 12, wherein the heat treatment temperature ranges from 80° C. to 180° C.

14. The lamination method for substrates as claimed in claim 12, wherein the step of laminating the second substrate to the first substrate is proceed between 180° C. to 220° C.

15. The lamination method for substrates as claimed in claim 12, further comprising a step of forming a surface-treated layer on the first substrate before the step of coating the resin composition on the first substrate.

16. The lamination method for substrate as claimed in claim 15, wherein the surface-treated layer is a release layer made of a material comprising one of the groups consisting of acrylic resin, polyimide, polyamide, polyamic acid, and polybenzoxazole, or combination thereof.

17. The lamination method for substrate as claimed in claim 16, wherein the release layer further comprises multiple inorganic particles.
